(19) United States
(12) Patent Application Publication
(10) Pub. No.: US 2015/0026070 A1
(43) Pub. Date: Jan. 22, 2015

(54) SYSTEMS AND METHODS FOR CORRELATING CARDHOLDER IDENTITY ATTRIBUTES ON A PAYMENT CARD NETWORK TO DETERMINE PAYMENT CARD FRAUD

(71) Applicant: MasterCard International Incorporated, Purchase, NY (US)

(72) Inventors: Peter J. Groarke, Dublin (IE); Mark B. Wiesman, Chesterfield, MO (US); John Delton Chisholm, Ballwin, MO (US); Ishfaq A. Lone, Dublin (IE)

(73) Assignee: MasterCard International Incorporated, Purchase, NY (US)

(21) Appl. No.: 13/943,461

(22) Filed: Jul. 16, 2013

(51) Int. Cl. G06Q 20/40; G06Q 20/38; G06Q 20/34

(52) U.S. Cl. CPC G06Q 20/4016; G06Q 20/34; G06Q 20/382
USPC 705/64

(57) ABSTRACT

A method and system for correlating cardholder identity attributes on a payment card interchange network using a computer device coupled to a database are provided. The method includes storing at a central store, personally identifiable information from an issuer for a plurality of payment card cardholders, the personally identifiable information encrypted to prevent payment card transaction data from being associated with the personally identifiable information, receiving, from a merchant, personally identifiable information during a payment card transaction, encrypting the received personally identifiable information, and comparing the encrypted stored personally identifiable information to the encrypted received personally identifiable information to determine a risk of fraud during the payment card transaction.

### BACKGROUND OF THE INVENTION

This invention relates generally to processing payment card transaction data and, more particularly, to computer systems and computer-based methods for detecting fraudulent transaction attempts in payment card transactions.

At least some known credit/debit card purchase transactions use an exchange of a number of financial card network messages between merchant, acquirer, and issuer members of a four-party interchange model. The financial card network messages may include, but are not limited to, requests, authorizations, advices, reversals, account status inquiry, presentments, purchase returns and chargebacks. Additionally, such financial card network messages include attributes such as, but, not limited to a Primary Account Number (PAN) that can be either real or virtual, a transaction amount, a merchant identifier, an acquirer identifier (which in combination with the merchant identifier uniquely identifies a merchant), transaction date-time, address verification information, and a transaction reference number.

In current four party interchange models, the financial card network message attributes are not shared with the interchange network. The merchant collects the attributes for the merchants use during a purchase transaction, but does not forward the attributes that could be used to personally identify the cardholder making the purchase transaction. In some cases privacy issues are of concern, in other cases the issuers consider the attributes to be proprietary.

Accordingly, it would be desirable to provide a system and/or method for reducing a risk of fraud in financial network transactions using a four-party model using personally identifiable information of the cardholder.

### BRIEF DESCRIPTION OF THE INVENTION

In one embodiment, a method for correlating cardholder identity attributes on a payment card interchange network includes storing at a central store, personally identifiable information from an issuer for a plurality of payment card cardholders, the personally identifiable information encrypted to prevent payment card transaction data from being associated with the personally identifiable information, receiving, from a merchant, personally identifiable information during a payment card transaction, encrypting the received personally identifiable information, and comparing the encrypted stored personally identifiable information to the encrypted received personally identifiable information to determine a risk of fraud during the payment card transaction.

In another embodiment, a computer system for processing data includes a memory device and a processor in communication with the memory device wherein , the computer system is programmed to store at a central store, personally identifiable information from an issuer for a plurality of payment card cardholders, the personally identifiable information encrypted to prevent payment card transaction data from being associated with the personally identifiable information, receive, from a merchant, personally identifiable information during a payment card transaction, encrypt the received personally identifiable information, and compare the encrypted stored personally identifiable information to the encrypted received personally identifiable information to determine a risk of fraud during the payment card transaction.

In yet another embodiment, one or more non-transitory computer-readable storage media has computer-executable instructions embodied thereon, wherein when executed by at least one processor, the computer-executable instructions cause the processor to store at a central store, personally identifiable information from an issuer for a plurality of payment card cardholders, the personally identifiable information encrypted to prevent payment card transaction data from being associated with the personally identifiable information, receive, from a merchant, personally identifiable information during a payment card transaction, encrypt the received personally identifiable information, and compare the encrypted stored personally identifiable information to the encrypted received personally identifiable information to determine a risk of fraud during the payment card transaction.

In another embodiment, a computer-implemented method for correlating identity attributes on a network includes storing at a central data storage device, personally identifiable information from first party for a plurality of cardholders, the personally identifiable information encrypted to prevent transaction data from being associated with the personally identifiable information, receiving, from a second party, personally identifiable information during a transaction, encrypting the received personally identifiable information, and comparing the encrypted stored personally identifiable information to the encrypted received personally identifiable information to determine a risk of fraud during the transaction.

In another embodiment, a computer system for processing data includes a memory device and a processor in communication with the memory device wherein the computer system is programmed to store at a central data storage device, personally identifiable information from a first party for a plurality of cardholders, the personally identifiable information encrypted to prevent transaction data from being associated with the personally identifiable information, receive, from a second party, personally identifiable information during a transaction, encrypt the received personally identifiable information, and compare the encrypted stored personally identifiable information to the encrypted received personally identifiable information to determine a risk of fraud during the card transaction.

### BRIEF DESCRIPTION OF THE DRAWINGS

FIGS. 1-6 show example embodiments of the methods and systems described herein.

FIG. 1A is a schematic diagram illustrating an example multi-party transaction card industry system 20 for enabling payment-by-card transactions in which merchants 24 and card issuers 30 do not need to have a one-to-one special relationship.

FIG. 1B is a schematic diagram illustrating another example multi-party transaction card industry system 20 for enabling payment-by-card transactions in which merchants 24 and card issuers 30 do not need to have a one-to-one special relationship.

FIG. 2 is a simplified block diagram of an example system including a plurality of computer devices in accordance with one example embodiment of the present invention.

FIG. 3 is an expanded block diagram of an example embodiment of a server architecture of the system including the plurality of computer devices in accordance with one example embodiment of the present invention.

FIG. 4 illustrates an example configuration of a client system shown in FIGS. 2 and 3.

FIG. 5 illustrates an example configuration of a server system shown in FIGS. 2 and 3.

FIG. 6 is a flow diagram of an example method 600 of correlating cardholder identity attributes on a payment card interchange network for detecting a risk of fraud in a payment card transaction.

### DETAILED DESCRIPTION OF THE INVENTION

Embodiments of the methods and systems described herein relate to reducing a risk of fraud in online payment card transactions, especially card-not-present (CNP) transactions conducted over the Internet. To ensure security of the cardholder identity data that is collected by a merchant or issuer during a CNP transaction. Information that can be used on its own or in combination with other information to identify, contact, or locate a single person, or to identify an individual in context is commonly referred to as Personally Identifiable Information (PII). Privacy laws protect at least some of this type of information to varying degrees based on each different jurisdiction. To make PII information available for risk-of-fraud determinations in CNP transactions a system and methods for protecting the information or anonymizing the information for other than risk-of-fraud scoring is desirable.

In various embodiments of the present disclosure a Cardholder Identity Store (CIS) maintains cardholder identity data, which is typically, but not always received from issuers in a central data store in a manner that prevents payment card transactions from being associated with any PII. Examples of methods of maintaining cardholder identity data in the CIS include storing a primary account number (PAN) with a corresponding list-of-lists of one-way hashed cardholder attributes or storing a one-way hashed PAN with a corresponding list-of-lists cardholder attributes, or a combination of both of the above. The list of cardholder attributes can include some or all of the following attributes email addresses, phone numbers, addresses, and IPAddresses. The contents of the Cardholder Identity store are furthermore access controlled.

In various embodiments, the CIS may be correlated with payment card transactions using a direct correlation or an indirect correlation. In a direct correlation, fields that are present in a payment transaction request authorization message that may also be present in an e-commerce message include, but are not limited to a PAN, and an address, for example, in an address verification service (AVS) message, email, IP address, and/or phone number. Accordingly, information collected by the merchant and inserted in the payment card transaction can be correlated with the cardholder identity store and this correlation used when determining fraud likelihood in the transaction. The CIS may also provide a hosted AVS service on-behalf of issuers.

Currently, there are a number of technologies to solve security-related issues and also ease-of-use issues in the field of credit/debit card purchase transactions. These technologies may include, but, are not limited to, a payment gateway, a 3-D Secure, and a digital wallet. Each of these technologies has a number of associated messages hereafter termed “e-commerce messages”. These e-commerce messages as well as containing a PAN may also contain the following “e-commerce attributes,” such as, but, not limited to a billing address, a shipping address, an email address, a phone number, an application account ID, for example, a digital wallet ID. Moreover, because the e-commerce messages are online messages, the IP address of the device used in the transaction may be readily determined if not contained directly in the messages. Moreover, if the e-commerce messages were correlated with the card payment transactions, that correlation could provide an indirect link from a PAN used in the transaction to associated e-commerce message attributes which could be compared to the cardholder identity data in the CIS.

The present disclosure describes a method and system of storing cardholder attributes in a manner compliant with all relevant privacy codes at a central location in such a way that the data can be correlated with Credit or Debit card payment transactions either directly or indirectly. Such a correlation can be used when measuring the relative likelihood of fraud in the transaction. The likelihood of fraud measure can be returned to the relevant parties, Merchant/Acquirer, Authorized Agent, or Issuer to enable them to make a more informed decision on whether to proceed with the transaction or not.

The methods and systems described herein may be implemented using computer programming or engineering techniques including computer software, firmware, hardware or any combination or subset thereof, wherein the technical effect may include at least one of: (a) receiving a qualifying message from a merchant or merchant/acquirer bank (b) transmitting the received qualifying message to a fraud processing hub (FPH), (c) extracting the primary account numbers (PAN) and other cardholder attributes from the messages, (d) hashing or otherwise encrypting the PANs and other attributes to control access to them, (e) comparing the hashed PANs and other cardholder attributes to local or remote stored hashed cardholder attributes, (f) increasing a fraud probability score for attributes that are mismatched between the received hashed PANs and attributes and the stored hashed PANs and attributes, and (g) incorporating he fraud probability score and cardholder identity matching results in any other fraud processing methods that may be available.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

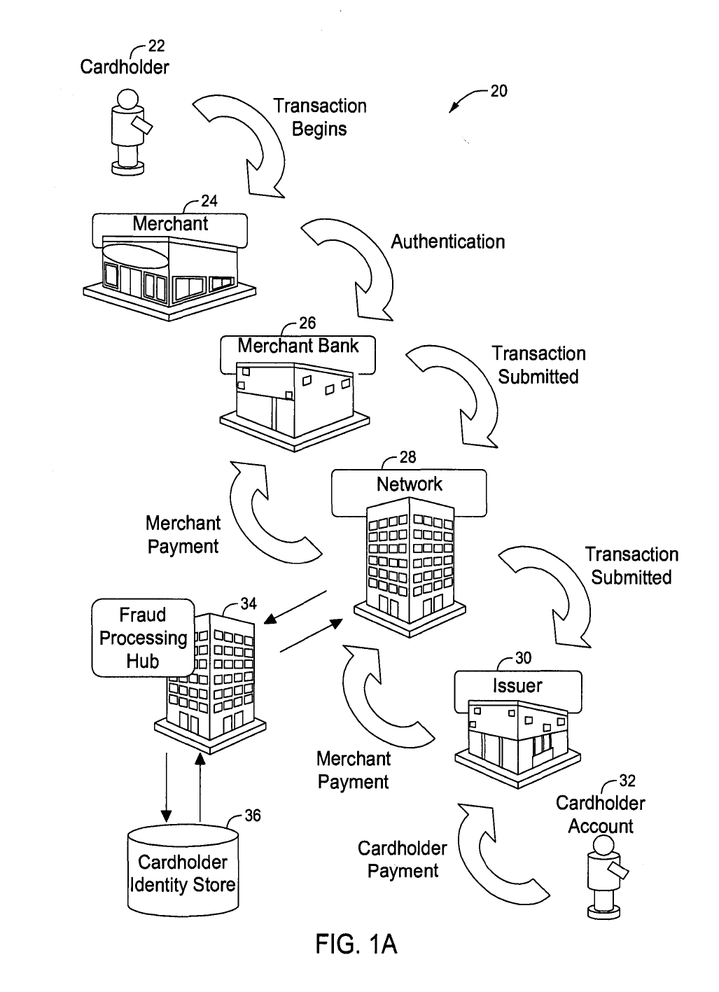

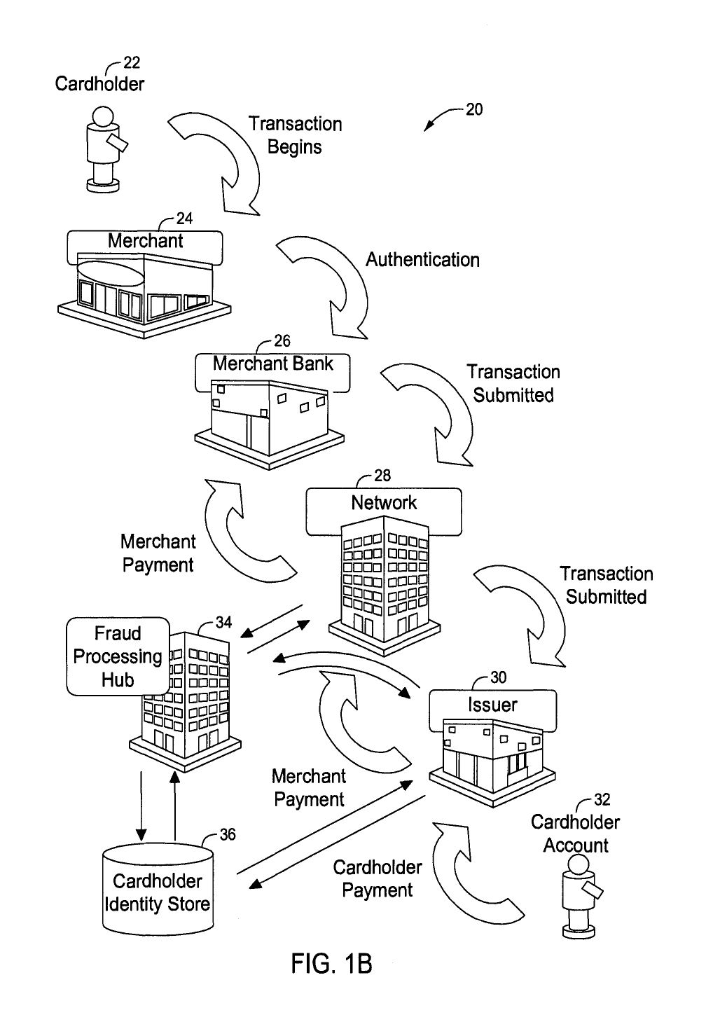

FIGS. 1A and 1B are schematic diagrams illustrating an example multi-party transaction card industry system 20 for enabling payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network includes a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf In this case, the point-of-sale terminal will be configured to communicate with the third party. Such a third party is usually called a “merchant processor,” an “acquiring processor,” or a “third party processor.”

The payment card transaction message is transmitted to an interchange network 28 for processing and for forwarding to a fraud processing hub (FPH) 34. FPH 34 is communicatively coupled to interchange network 28 and may be an integral part of interchange network 28, may be part of a third party service provider's infrastructure, or may be part of an issuer or group of issuers' infrastructure. FPH 34 is communicatively coupled to a cardholder identity store (CIS) 36. CIS 36 stores cardholder identity data, which is data acquired by merchant 24, merchant bank 26, issuer 30, combinations thereof, or any other entity that is able to acquire cardholder identifying data that can uniquely identify a cardholder directly or indirectly. FPH 34 and CIS 36 are configured to correlate data from authorization request messages with corresponding data from stored cardholder identifying data to facilitate a determination of a risk-of-fraud associated with the transaction, for example, by determining a probability of fraud score. Such a score permits an allocation of risk to the parties of the four party interchange model. For example, if a score for a payment card transaction is returned that indicates the transaction is relatively risky, issuer 30 can use that score to authorize or decline the transaction. However, if merchant 24 overrides the decision of issuer 30, merchant 24 assumes the risk associated with the transaction.

As shown in FIG. 1A, CIS 36 communicates directly with FPH 34. FIG. 1B illustrates an embodiment where CIS 36 communicates with issuer 30 directly or in some embodiments, an issuer agent directly. Information passed between FPH 34 and CIS 36 is directly controlled by issuer 30 and uses interchange network 28 to facilitate the communication. Such an embodiment might be used in an instance where for privacy concerns issuer 30 is reluctant or legally unable to cede control of the cardholder identifying data to interchange network 28 or to FPH 34 directly.

Using interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

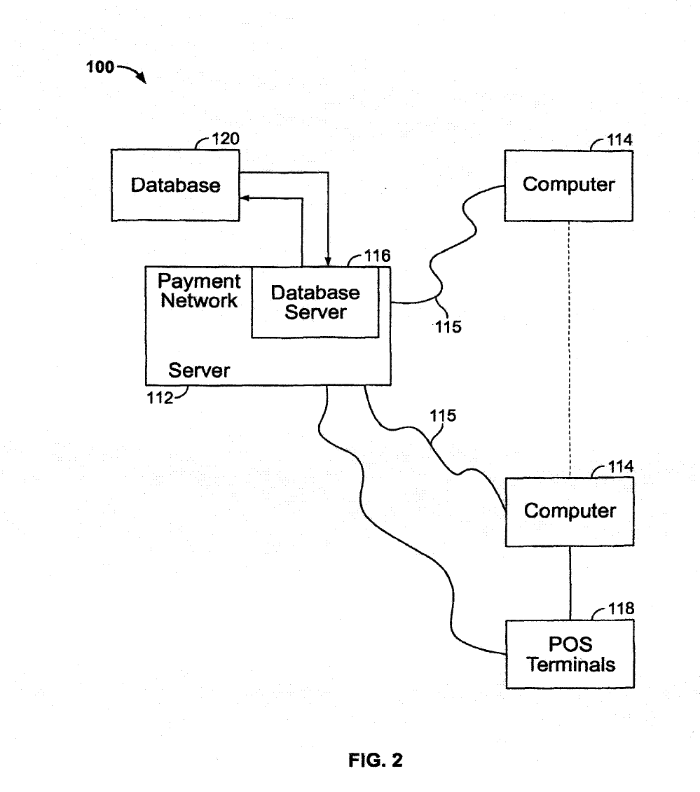

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example processing system 100 including a plurality of computer devices in accordance with one embodiment of the present invention. In the example embodiment, system 100 may be used for performing payment-by-card transactions and/or correlating cardholder identifying data from received during a payment card transaction with cardholder identifying data stored within CIS 36. For example, system 100 may receive cardholder identifying data from various sources including, but not limited to payment card transactions. The cardholder identifying data is forwarded to FPH 34 for further processing to determine a risk-of-fraud probability of the payment card transaction. One of the steps of the risk-of-fraud determination is retrieving stored cardholder identifying data from CIS 36 and comparing elements of the received cardholder identifying data with corresponding elements of the stored cardholder identifying data. Mismatches between the cardholder identifying data between the received and stored data indicates potential risk-of-fraud. A risk-of-fraud score is returned to interchange network 28 for processing in the authorization request or other processes as needed.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store cardholder identifying data, algorithms for determining risk-of-fraud or other data for processing according to the methods described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, a biller, and/or a risk-of-fraud system. The risk-of-fraud system may be associated with interchange network 28, issuers 30 or with an outside third party in a contractual relationship with interchange network 28 or issuers 30. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

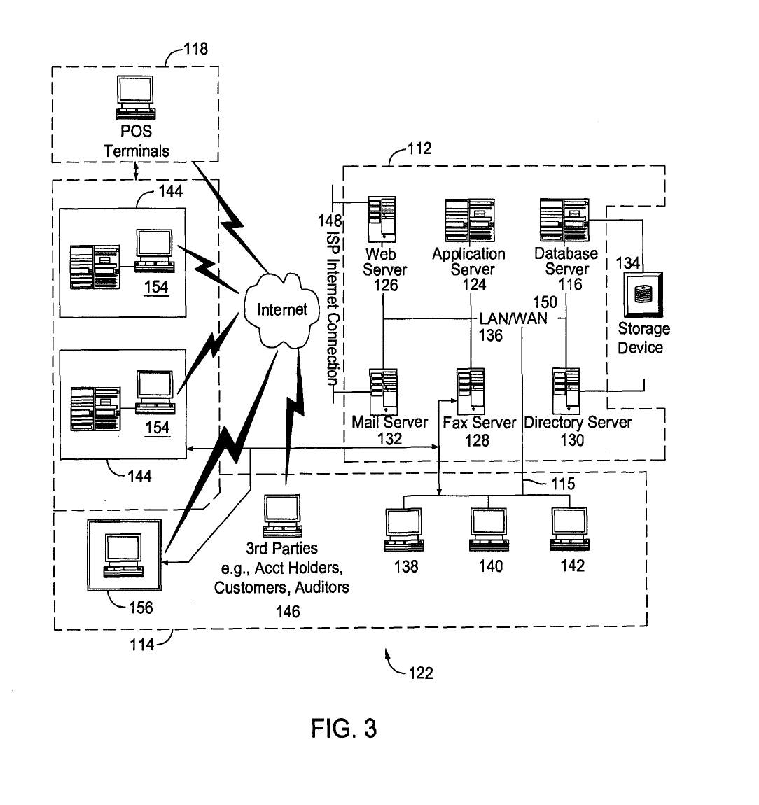

FIG. 3 is an expanded block diagram of an example embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

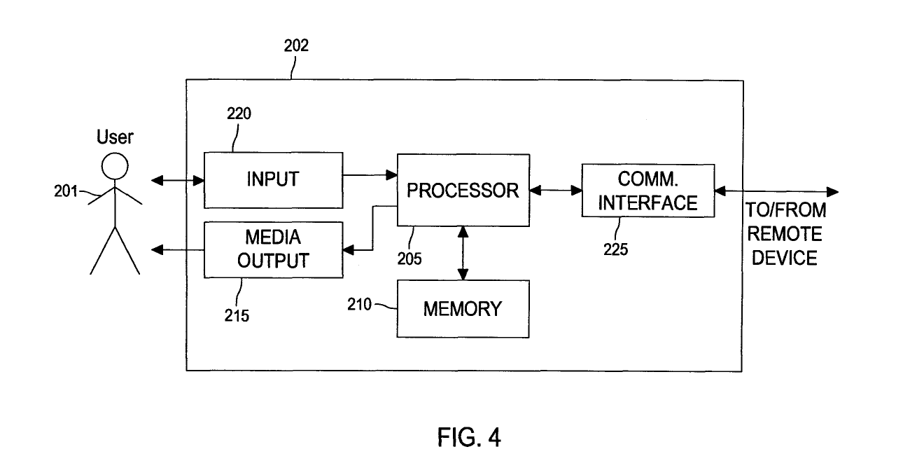

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

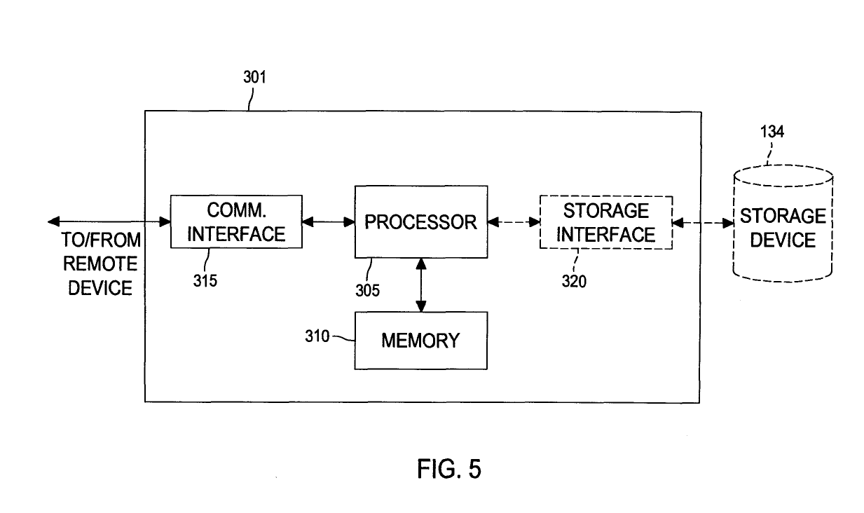

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

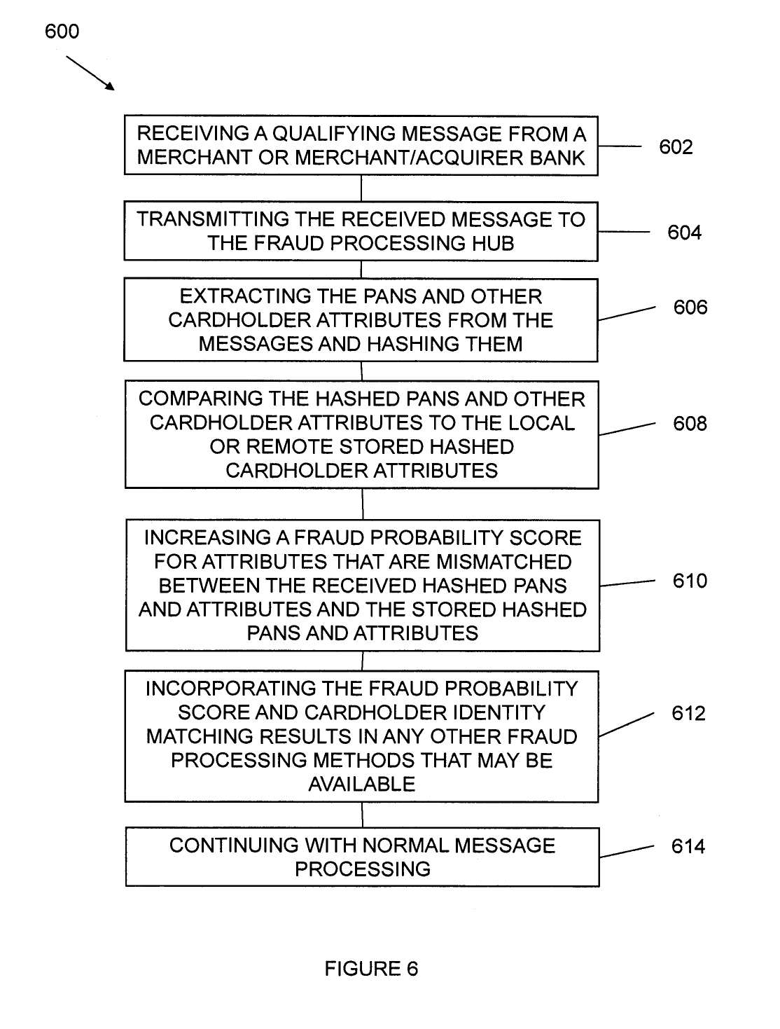

FIG. 6 is a flow diagram of an example method 600 of correlating cardholder identity attributes on a payment card interchange network for detecting a risk of fraud in a payment card transaction. In the example embodiment, method 600 includes receiving 602 a qualifying message from a merchant or merchant/acquirer bank. The received message is transmitted 604 to FPH 34. In various embodiments, FPH 34 may be embodied within network 28, may be a part of system 20 communicatively coupled to network 28, may be located within a third-party service trusted by issuers 30, or FPH 34 may be a part of one or issuers' systems where cardholder identities are stored at the issuer site but access is made available to FPH 34 via a secure connection.

Method 600 further includes extracting 606 the PANs and other cardholder attributes from the messages and hash them. The hashed PANs and other cardholder attributes are compared 608 to local or remote stored hashed cardholder attributes. A fraud probability score is increased 610 for attributes that are mismatched between the received hashed PANs and attributes and the stored hashed PANs and attributes. The fraud probability score and cardholder identity matching results are incorporated 612 in any other fraud processing methods that may be available. Method 600 then continues 614 with normal message processing as described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, 305, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the invention may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

The above-described embodiments of a method and system of correlating cardholder identifying data provides a cost-effective and reliable means for providing a risk-of-fraud determination for payment card transactions. More specifically, the methods and systems described herein facilitate maintaining cardholder identifying data including PII confidential in accordance with local laws and regulations. As a result, the methods and systems described herein facilitate reducing fraudulent transactions in a payment card network in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for correlating cardholder identity attributes on a payment card interchange network, the method implemented using a computer device coupled to a memory device, the method comprising:
storing at a central store, personally identifiable information from an issuer for a plurality of payment card cardholders, the personally identifiable information encrypted to prevent payment card transaction data from being associated with the personally identifiable information;
receiving, from a merchant, personally identifiable information during a payment card transaction;
encrypting the received personally identifiable information; and
comparing the encrypted stored personally identifiable information to the encrypted received personally identifiable information to determine a risk of fraud during the payment card transaction.

2. The computer-based method of claim 1, wherein encrypting the received personally identifiable information comprises encrypting the received personally identifiable information using a one-way hash.

3. The computer-based method of claim 1, wherein storing at a central store comprises storing at a central store located at the payment card interchange.

4. The computer-based method of claim 1, wherein storing at a central store comprises storing at a central store located at a third party service provider.

5. The computer-based method of claim 1, wherein storing at a central store, personally identifiable information comprises storing at a central store, personally identifiable information from the issuer includes personally identifiable information of the cardholder received during initiation of the cardholder account.

6. The computer-based method of claim 1, wherein storing at a central store, personally identifiable information comprises storing at a central store, personally identifiable information from the issuer includes personally identifiable information of the cardholder received during a payment card transaction conducted between the cardholder and the merchant.

7. The computer-based method of claim 1, wherein comparing the encrypted stored personally identifiable information to the encrypted received personally identifiable information comprises comparing the encrypted stored personally identifiable information to the encrypted received personally identifiable information contemporaneously with an associated payment card transaction.

8. A computer system for processing data, the computer system comprising a memory device and a processor in communication with the memory device, the computer system programmed to:
store at a central store, personally identifiable information from an issuer for a plurality of payment card cardholders, the personally identifiable information encrypted to prevent payment card transaction data from being associated with the personally identifiable information;
receive, from a merchant, personally identifiable information during a payment card transaction;
encrypt the received personally identifiable information; and
compare the encrypted stored personally identifiable information to the encrypted received personally identifiable information to determine a risk of fraud during the payment card transaction.

9. The computer system of claim 8, wherein said computer system is programmed to encrypt the received personally identifiable information using a one-way hash.

10. The computer system of claim 8, wherein said computer system is programmed to store at a central store located at the payment card interchange.

11. The computer system of claim 8, wherein said computer system is programmed to store at a central store located at a third party service provider.

12. The computer system of claim 8, wherein said computer system is programmed to store at a central store, personally identifiable information from the issuer includes personally identifiable information of the cardholder received during initiation of the cardholder account.

13. The computer system of claim 8, wherein said computer system is programmed to store at a central store, personally identifiable information from the issuer includes personally identifiable information of the cardholder received during a payment card transaction conducted between the cardholder and the merchant.

14. The computer system of claim 8, wherein said computer system is programmed to compare the encrypted stored personally identifiable information to the encrypted received personally identifiable information contemporaneously with an associated payment card transaction.

15. One or more non-transitory computer-readable storage media having computer-executable instructions embodied thereon, wherein when executed by at least one processor, the computer-executable instructions cause the processor to:
store at a central store, personally identifiable information from an issuer for a plurality of payment card cardholders, the personally identifiable information encrypted to prevent payment card transaction data from being associated with the personally identifiable information;
receive, from a merchant, personally identifiable information during a payment card transaction;
encrypt the received personally identifiable information; and
compare the encrypted stored personally identifiable information to the encrypted received personally identifiable information to determine a risk of fraud during the payment card transaction.

16. The computer-readable storage media of claim 15, wherein the computer-executable instructions further cause the processor to encrypt the received personally identifiable information using a one-way hash.

17. The computer-readable storage media of claim 15, wherein the computer-executable instructions further cause the processor to store at a central store located at the payment card interchange.

18. The computer-readable storage media of claim 15, wherein the computer-executable instructions further cause the processor to store at a central store located at a third party service provider.

19. The computer-readable storage media of claim 15, wherein the computer-executable instructions further cause the processor to store at a central store, personally identifiable information from the issuer includes personally identifiable information of the cardholder received during initiation of the cardholder account.

20. The computer-readable storage media of claim 15, wherein the computer-executable instructions further cause the processor to store at a central store, personally identifiable information from the issuer includes personally identifiable information of the cardholder received during a payment card transaction conducted between the cardholder and the merchant.
